(19) United States
(12) Patent Application Publication
(10) Pub. No.: US 2008/0007716 A1
(43) Pub. Date: Jan. 10, 2008

(54) Raman scattering light observation apparatus and endoscope apparatus

(75) Inventor: Makoto Igarashi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Medical Systems Corp., Tokyo (JP)

(21) Appl. No.: 11/818,294

(22) Filed: Jun. 14, 2007

(30) Foreign Application Priority Data
Sep. 5, 2005 (JP) 2005-257035

(51) Int. Cl. G01J 3/44; G01N 21/00

(52) U.S. Cl. 356/72; 356/301

(57) ABSTRACT

A Raman scattering observation apparatus is provided with a light source device for radiating incoherent first and second band-pass light each with the first and the second wavelengths as center wavelengths respectively, and a filter unit set to selectively extract a Raman scattering light component as a third wavelength, which contains a fluorescent component injected from an observation object to which the first and the second band-pass light are irradiated. The first and the second detection signals through the filter unit detected by the detection unit corresponding to the first and the second band-pass light are subjected to the differential process in the differential process unit.

### BACKGROUND OF THE INVENTION

1. Field of the Invention

The present invention relates to a Raman scattering light observation apparatus and an endoscope apparatus for observing Raman scattering light from an observation object that emits fluorescence, for example, a body tissue while reducing the influence of the fluorescence.

2. Description of the Related Art

The endoscope is a medical device employed for noninvasively observing the inside of the internal organ such as a digestive tract. In the general endoscopic inspection, the mucosal observation has been performed using the white light to show the slight change in tone of the mucosa in natural color such that the subtle lesion in the magnitude of several millimeters may be detected.

However, the generally employed endoscopic inspection using the white light is inadequate in view of the viewability of Dysplasia (precancerous lesion) generated on the Barrett's esophagus, or diagnosis for discrimination between the tumor and non-tumor of the colon polyp. Removal of the body tissue (biopsy) and histopathological inspection are required to specify the level of the benignancy and malignity of the body tissue. However, such drawback as the sampling error in the process of the removal of the tissue and increase in the cost and the inspection time caused by the histopathological inspection have occurred.

The new optical diagnostic technology such as Light Scattering Spectroscopy, the fluorescent imaging, Optical Coherence Tomography (OCT) have been proposed as the attempt to perform further detailed observation with respect to the property of the body tissue.

Above all, the Raman spectroscopy has attracted the attention as the method for optically detecting the information inherent to the respective molecules (that is, molecular fingerprint), which allows identification of the protein and DNA which form the body tissue in accordance with the difference in the molecular structure in principle. The Raman spectroscopy is considered to be effective for diagnosing and discriminating whether the mucosal polyp is the tumor or non-tumor.

The Raman spectroscopy has a potential to allow the diagnosis of the body tissue based on the molecular structure.

As the Raman scattering light is considerably weak compared with the fluorescent light, it is necessary to remove the fluorescence (component) from the light reflecting from the body tissue as the observation object for the purpose of obtaining quality Raman scattering light from the observation object as the body tissue which emits the fluorescence.

The attempt to separate the fluorescence and the Raman scattering light from the reflecting light obtained from the observation object has been made. For example, Japanese Unexamined Patent Application No. 2004-61411 discloses that the Raman scattering light is separated from the fluorescence spatially through the non-linear Raman spectroscopy.

Japanese Unexamined Patent Application No. 10-148573 discloses that the Raman scattering light as the component of the object signal which changes with time and the fluorescence as the component other than the aforementioned component are separated from the observation light through high-speed sweeping of the excited wavelength through the Electronically Turned Tunable Laser (hereinafter referred to as ETT laser).

### SUMMARY OF THE INVENTION

A Raman scattering light observation apparatus of the present invention includes a light source device for irradiating at least an incoherent first band-pass light with a center wavelength as a first wavelength, and an incoherent second band-pass light with a center wavelength as a second wavelength different from the first wavelength at a time interval, a filter unit which receives an incident Raman scattering light that contains a fluorescent component from an observation object to which the first and the second band-pass light are irradiated at the time interval, so as to selectively extract a Raman scattering light component of the observation object as a third wavelength different from the first and the second wavelengths, a detection unit for detecting a light extracted by the filter unit, a signal process unit for subjecting a plurality of detection signals outputted from the detection unit to a signal process, and a differential process unit provided in the signal process unit for executing a differential process with respect to a first detection signal detected by the detection unit via the filter unit upon irradiation of the first band-pass light, and a second detection signal detected by the detection unit via the filter unit upon irradiation of the second band-pass light.

An endoscope apparatus according to the present invention includes an endoscope with an insertion portion to be inserted into a body cavity, a light radiation portion provided at a distal end portion of the insertion portion for radiating at least an incoherent first band-pass light with a first wavelength as a center wavelength and an incoherent second band-pass light with a second wavelength as a center wavelength that is different from the first wavelength to an observation site in the body cavity at a time interval, a filter unit provided at a distal end portion of the insertion portion for receiving an incident Raman scattering light that contains a fluorescent component from the observation site to which the first and the second band-pass light are irradiated at a time interval to selectively extract a Raman scattering light component at the observation site as a third wavelength which is different from the first and the second wavelengths, a detection unit for detecting a light extracted by the filter unit, a signal process unit for subjecting a plurality of detection signals outputted from the detection unit to a signal process, and a differential process unit provided in the signal process unit for executing a differential process with respect to a first detection signal detected by the detection unit via the filter unit upon irradiation of the first band-pass light, and a second detection signal detected by the detection unit via the filter unit upon irradiation of the second band-pass light.

### BRIEF DESCRIPTION OF THE DRAWINGS

FIG. 1 is a view showing a structure of a Raman scattering light observation apparatus according to a first embodiment of the present invention;

FIG. 2 is a view showing a rotary filter shown in FIG. 1;

FIG. 3 is a view representing the transmissivity characteristic of the rotary filter shown in FIG. 1;

FIG. 4 is a view representing the transmissivity characteristic of a band-pass filter shown in FIG. 1;

FIG. 5A is a graphical representation of two Raman scattering light observed by the apparatus shown in FIG. 1;

FIG. 5B is a view showing a result of the differential process with respect to the two Raman scattering light;

FIG. 6 is a view showing the structure of the Raman scattering light observation apparatus as a modified example of the first embodiment;

FIG. 7 is a view showing the structure of the endoscope apparatus which forms a Raman scattering light observation apparatus according to a second embodiment;

FIG. 8 is a view showing a structure of a distal end portion of an endoscope according to the second embodiment;

FIG. 9 is a view showing a structure of the distal end portion of the endoscope as a modified example of the second embodiment;

FIG. 10 is a view showing a structure of the distal end portion of the endoscope according to a third embodiment;

FIG. 11 is a view showing a structure of the endoscope apparatus which forms a Raman scattering light observation apparatus according to a fourth embodiment;

FIG. 12 is a view showing a structure of the distal end portion of the endoscope according to the fourth embodiment;

FIG. 13 is a view showing the structure of a signal process unit of a modified example of the fourth embodiment;

FIG. 14 is an explanatory view showing an endoscope apparatus according to a fifth embodiment where a liquid crystal tunable filter is employed for the light source device;

FIG. 15 is a view showing a structure of the distal end portion of an endoscope according to a sixth embodiment;

FIG. 16 is a view showing a structure of the distal end portion of the endoscope according to the sixth embodiment;

FIG. 17 is a view showing a signal process unit equipped with a correction circuit for correcting the fluorescent component according to a seventh embodiment;

FIG. 18 is a graphical representation of two Raman scattering light observed with the Raman scattering light observation apparatus when the relative positional relationship between the detector and the observation object changes;

FIG. 19 is a view showing the structure of the signal process unit which exhibits the function for correcting the displacement; and

FIG. 20 is a view showing a structure of the signal process unit for correcting the variation in the fluorescent component and the displacement.

### DETAILED DESCRIPTION OF THE PREFERRED EMBODIMENTS

Embodiments of the present invention will be described referring to the drawings.

### First Embodiment

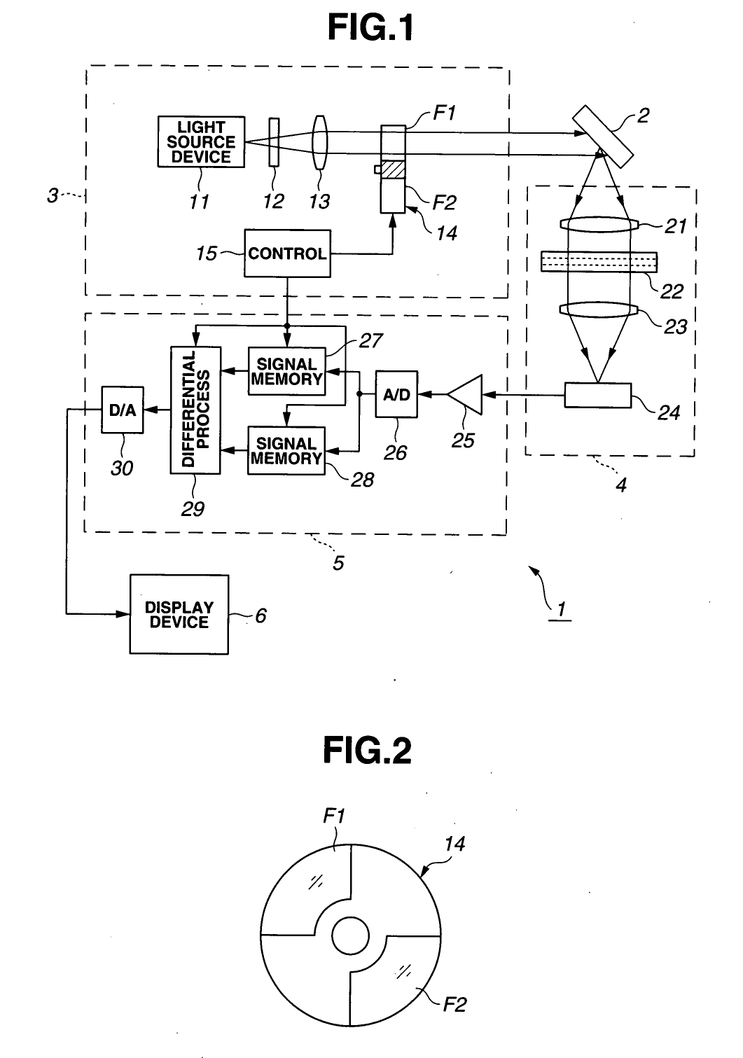

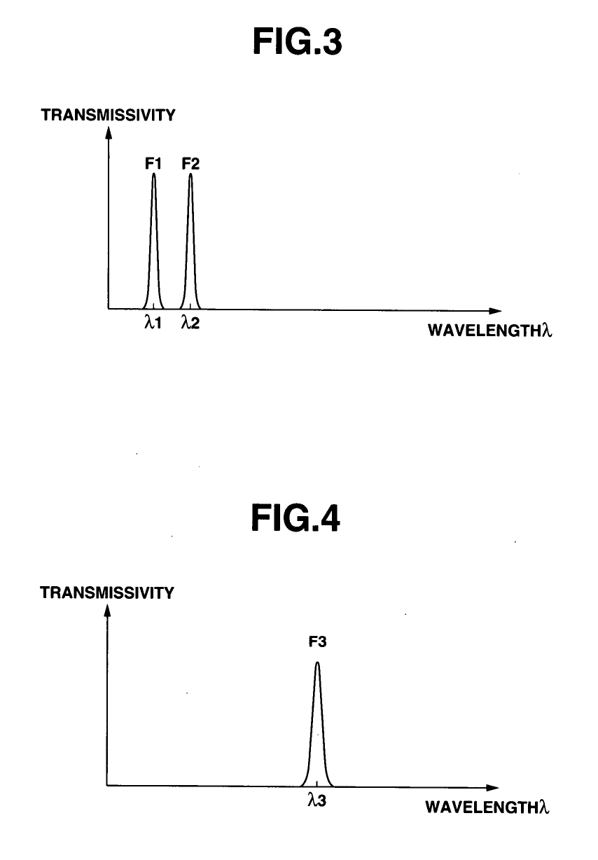

FIGS. 1 to 6 relate to a first embodiment of the present invention. FIG. 1 shows an entire structure of a Raman scattering light observation apparatus according to the first embodiment of the present invention. FIG. 2 shows a structure of a rotary filter. FIG. 3 shows transmissivity characteristics of the filter attached to the rotary filter. FIG. 4 shows transmissivity characteristics of the band-pass filter.

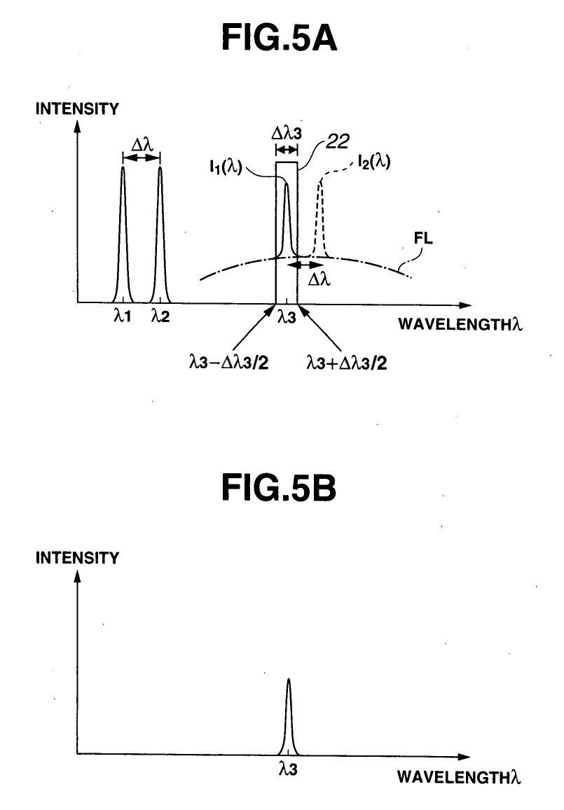

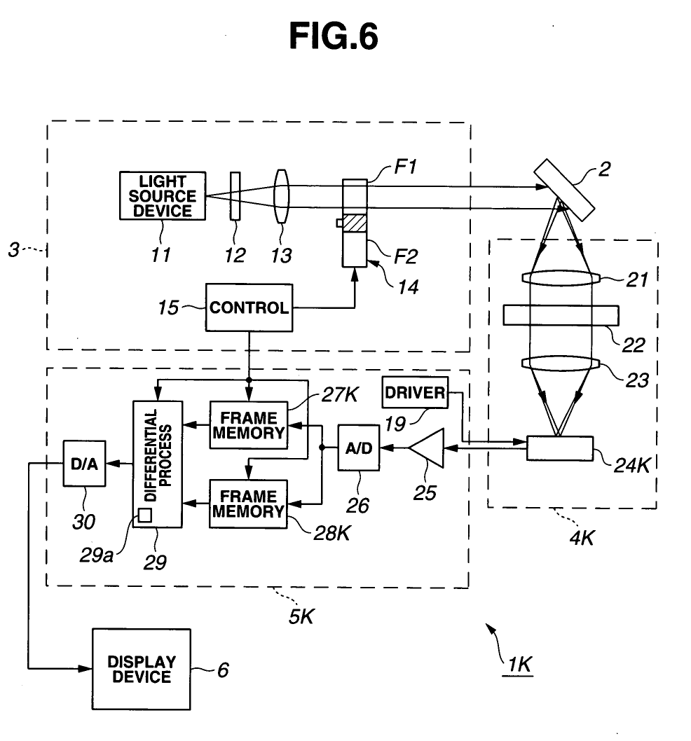

FIG. 5A shows how the Raman scattering light each containing the fluorescent component are detected by two band-pass light, respectively. FIG. 5B shows the result of the differential process performed with respect to the two detected Raman scattering light. FIG. 6 shows an entire structure of the Raman scattering light observation apparatus as a modified example.

It is an object of the present invention to provide a Raman scattering light observation apparatus capable of separating the fluorescence and Raman scattering light from the observation object which emits the fluorescence such as the body tissue with the simple structure at low costs.

Referring to FIG. 1, a Raman scattering light observation apparatus 1 according to the first embodiment of the present invention includes a light source device 3 which generates excited light (hereinafter referred to simply as light) for irradiating a living body 2 as an observation object which emits fluorescence (with fluorescent characteristic), a detection unit 4 for detecting a Raman scattering light to be scattered (or radiated) by the living body 2, a signal processing unit 5 for subjecting the detection signal detected by the detection unit 4 to the signal process, and a display device 6 for displaying the detection result of the Raman scattering light.

The light source device 3 includes a light source 11 for emitting incoherent light of a halogen lamp, a xenon lamp, a light-emitting diode (hereinafter referred to as LED) and the like, and a heat ray cut filter 12 for cutting the far-infrared emission as the heat ray.

The light source device 3 includes a collimate lens 13 for collimating the light from the light source 11 into parallel light flux, a rotary filter 14 disposed in the parallel light flux and rotated to generate two band-pass light each with a narrow band alternately at a time interval, and a control unit 15 for controlling the rotation of the rotary filter 14.

FIG. 2 shows an exemplary form of the rotary filter 14. The rotary filter 14 includes fan-like narrow band transmission filters F1 and F2 at, for example, two opposite positions in the circumferential direction of the rotary plate to be rotated.

The filters F1 and F2 are alternately brought into the optical path in synchronization with a control signal of the control unit 15 with respect to the rotary filter 14 such that two incoherent narrow band-pass light each having the different center wavelength are sequentially irradiated to the living body 2 as the observation object at a relatively short time interval.

FIG. 3 represents spectroscopic transmission characteristics of the filters F1 and F2, respectively.

The filters F1 and F2 are set to transmit the narrow band lights each with the center wavelength of λ₁ and λ₂, respectively.

Referring to FIG. 5A, the wavelength difference between the center wavelengths λ₁ and λ₂, that is, λ₂−λ₁ (=Δλ) is defined such that the spectral value (transmission characteristic value) of the fluorescent component does not change as described later. The center wavelengths λ₁ and λ₂ are set to the values which are approximated with each other.

The detection unit 4 includes a collimate lens 21 for collimating the light which contains the Raman scattering light from the living body 2, and a band-pass filter 22 disposed in the parallel light flux collimated by the collimate lens 21 as a filter device where the passing wavelength band is set to allow selective passage of the Raman scattering light component.

As shown by the dotted line in FIG. 1, a plurality of band-pass filter elements may be laminated to be formed as the band-pass filter 22 so as to realize the desired band-pass filter characteristic with the narrow band.

The detection unit 4 includes a condenser lens 23 for condensing the light which has transmitted the band-pass filter 22, and a detector 24 for detecting the condensed light so as to be subjected to the photoelectric conversion. The detector 24 is formed of a photodiode for detecting the electric signal which has been received and photoelectric converted signal so as to be outputted.

The light radiated or scattered from the living body 2 to be collimated by the collimate lens 21 and guided to the band-pass filter 22 has its Raman scattering light component specific to the molecules to constitute the tissue of the living body 2 extracted during transmission of the band-pass filter 22.

The light which has transmitted the band-pass filter 22 is condensed to the detector 24 by the condenser lens 23.

The passing wavelength band of the band-pass filter 22 is set to have the wavelength different from the center wavelengths λ₁ and λ₂ of the band-pass light irradiated to the living body 2 so as to selectively pass the Raman scattering light generated in the living body 2.

The normal reflecting light reflected on the living body 2 may be removed during the transmission of the band-pass filter 22. In the aforementioned transmission of the band-pass filter 22, the autofluorescence spectral component (relative to the Raman scattering light component) of the living body 2 intrudes as noise. The fluorescent component noise may be effectively eliminated through the differential process in the signal process unit 5.

FIG. 4 shows an example of the spectroscopic transmission characteristics of the band-pass filter 22 (The spectroscopic transmission characteristic of the band-pass filter 22 is designated as a code F3 in FIG. 4 for simplification). The band-pass filter 22 has the narrow passage wavelength band with the center wavelength set to λ₃ so as to pass the Raman scattering light specific to the molecules that constitute the living body 2.

The center wavelength λ₃ of the band-pass filter 22 is set to the wavelength position shifted toward the longer wavelength side with respect to the center wavelengths λ₁ and λ₂ of the band-pass light through the narrow band transmission filters F1 and F2, respectively attached to the rotary filter 14 of the light source device 3.

The center wavelength λ₃ of the band-pass filter 22 is set to pass a stokes line of the tissue of the living body 2, more specifically, the molecule which constitutes the tissue of the living body 2 (observation target).

In this embodiment, the passing wavelength band of the band-pass filter 22 is set to allow the Raman stokes line of a single molecule. However, a plurality of band-pass filters 22 may be provided or the band-pass filter 22 may be structured to set the passing wavelength band variable so as to provide a plurality of passing wavelength bands corresponding to plural kinds of molecules as described below.

The signal process unit 5 includes an amplifier 25 for amplifying the detection signal as the electric signal outputted from the detector 24, and an A/D conversion circuit 26 for converting the signal amplified in the amplifier 25 into a digital signal.

The signal process unit 5 includes a pair of signal memories 27 and 28 for temporarily storing the signal outputted from the A/D conversion circuit 26, a differential process circuit 29 for performing the differential calculation with respect to the respective output signals from the signal memories 27 and 28, and a D/A conversion circuit 30 for converting the digital signal outputted from the differential process circuit 29 to the analog signal.

The operation of the above-structured embodiment will be described.

The signals outputted from the D/A conversion circuit 30 may be in the form of numerical values and displayed on a display device 6. As described below, an imaging lens system may be employed in place of the collimate lens 21, and an image pickup device may further be used as the detector 24 to obtain a two-dimensional image signal of the Raman scattering light such that the Raman imaging is displayed on the display device 6.

In the embodiment, the differential process performed in the differential process circuit 29 serves to reduce the fluorescent component radiated from the living body 2 to allow the observation of the Raman scattering light with good SNR (S/N). Generally, in the case where the wavelength of the light irradiated to the living body 2 (excited wavelength for obtaining the Raman scattering light) λ is changed by the amount corresponding to Δλ, the wavelength which generates the Raman band (Raman stokes line) shifts by Δλ while keeping the fluorescent intensity substantially unchanged so long as the Δλ is small.

FIGS. 5A and 5B represent how the Raman scattering light is obtained by mitigating the influence of the fluorescence.

Referring to FIG. 5A, two light each having the center wavelength λ₁ and the center wavelength λ₂ different from the wavelength λ₁ by Δλ, respectively are irradiated to the living body 2 in a time division manner so as to generate each spectrum I₁(λ), I₂(λ) as the sum of the Raman scattering light component and the fluorescent component in the living body 2 at the respective irradiation intervals.

Referring to FIG. 5A, the broad spectrum portion shown by the chain double-dashed line represents the fluorescent component FL, and the acute peak portion of the spectrum corresponds to the Raman scattering light component for graphically showing the aforementioned characteristics.

In the case where the Δλ is the small value, the time-variable component in the predetermined wavelength range from λ₃−Δλ₃/2 to λ₃+Δλ₃/2 corresponds to the Raman scattering component. The Raman scattering intensity I^{R} corresponding to the result of the differential process of the intensity detected in the aforementioned wavelength range becomes substantially equal to the Raman scattering component generated from the living body 2.

The band-pass filter 22 is set for the purpose of appropriately performing the differential process thus described. Referring to FIG. 5A, the passing band of the band-pass filter 22 is set at the wavelength position of the center wavelength λ₃ where the Raman scattering light is generated upon irradiation of the light with the center wavelength λ₁ to the living body 2 so as to have the passing band width Δλ₃ for passing the Raman scattering light component.

In the aforementioned set state where the light with the center wavelength λ₂ is irradiated to the living body 2 as indicated by the dashed line shown in FIG. 5A, the resultant Raman scattering light component is at the wavelength position apart from the passing band of the band-pass filter 22, and only the fluorescent component FL is allowed to pass into the passing band of the band-pass filter 22.

In the above set state, the signals corresponding to the spectrums I₁(λ) and I₂(λ) each as a sum of the Raman scattering light component and the fluorescent component detected by the detector 24 are stored in the signal memories 27 and 28, respectively. The signals stored in the signal memories 27 and 28 are outputted to the differential process circuit 29 to execute the differential processes with respect to the signals corresponding to those spectrums I₁(λ) and I₂(λ) to obtain the Raman scattering intensity I^{R} equivalent to the result of the differential process. The obtained Raman scattering intensity I^{R} is displayed on the display device 6.

The Raman scattering intensity I^{R} to be observed is derived from the following formula 1.

$${I}^{R} = {\sum }_{λ = {λ}_{S} - Δ {λ}_{S} / 2}^{λ = {λ}_{S} + {Δλ}_{S} / 2} \{ {I}_{1} ( λ ) - {I}_{2} ( λ ) \} \qquad ( 1 )$$

### It is assumed that in the calculation process using the formula 1, the component which makes the value of I₁(λ)−I₂(λ) negative is not added to the calculation.

Non Patent Document 1 by M. G Shim et al. describes about generation of the distinctive Raman band that differentiate the normal from the tumor in the wave number band from 800 cm⁻¹ to 180 cm⁻¹ as a result of the measurement of the Raman spectrum of in vivo observation object such as the esophageal mucosa and the large intestine mucosa.

(Non Patent Document 1) Martin G Shim, Louis-Michel Wong Kee Song, Norman E. Marcon and Brian C. Wilson, “In vivo Near-infrared Raman Spectroscopy: Demonstration of Feasibility During Clinical Gastrointestinal Endoscopy,”, Photochem. Photobiol., 72(1), 146-150, (2000)

For example, amino acid in the band of 1620 cm⁻¹ or nucleotide in the band of 1585 cm⁻¹ may be exemplified. Meanwhile, Non Patent Document 2 describes about the difference of in vivo Raman spectrum between the normal tissue and the precancerous lesion of the uterine cervic in the similar wave number band as described above.

(Non Patent Document 2) A. Mahadevan-Jansen, Michele Follen Mitchell, Nirmala Ramanujam, Urs Utzinger and Rebecca Richards-Kortum, “Development of a Fiber Optics Probe to Measure NIR Raman Spectra of Cervical Tissue In Vivo, “Photochem. Photobiol., 68 (3), 427-431, (1998)

It is preferable to use the excited light with the wavelength in the near-infrared range for the purpose of suppressing the fluorescent component from the fluorescent illuminant such as the living body 2. The excited light source with the wavelength in the range from 700 nm to 1000 nm is mostly used in the Raman measurement with respect to the intense fluorescent illuminant.

Each of the wavelengths λ₁ and λ₂ shown in FIG. 3 may have the value ranging from about 700 nm to 1000 nm. The wavelength λ₃ shown in FIG. 4 may have the value ranging from 1300 nm to 2200 nm in consideration for the Raman shift amount of the living tissue such as the esophagus and large intestine.

The differential process with respect to the signals outputted from the signal memories 27 and 28 executed in the differential process circuit 29 allows the observation of the Raman scattering light of the living body 2 separated from the fluorescent component.

The observation result of the Raman scattering light may be used to diagnosis with respect to the living body 2 as the observation object to be diagnosed (diagnosis object) based on the molecular structure.

The embodiment may be simply structured at lower costs without requiring the costly laser system, for example, the ultrashort pulse laser as disclosed in the related art.

The inexpensive light source device 11 such as the halogen lamp is used and the rotary filter 14 is rotated to generate the band-pass light with two different wavelengths at time intervals so as to be irradiated to the living body 2.

The Raman scattering light which contain the fluorescence from the living body 2 is extracted through the band-pass filter 22 so as to be converted into the electric signal in the detector 24. Then the differential process is executed in the differential process circuit 29 to separate the fluorescent component signal such that the signal component of the Raman scattering light is obtained.

A scanner unit for two dimensionally scanning the detection unit 4 may be provided to obtain the two-dimensional information of the Raman scattering light, that is, the image information.

In the aforementioned structure, the imaging lens system may be formed of the lenses 21 and 23 shown in FIG. 1, and the image pickup device is used as the detector 24 for image pickup (that is, obtaining the two-dimensional map of the detection signal intensity) such that the observation apparatus to obtain the two-dimensional information of the Raman scattering light may be structured.

FIG. 6 shows the structure of a Raman scattering light observation apparatus 1K for providing the two-dimensional information as described above. In the Raman scattering light observation apparatus 1K, the lenses 21 and 23 shown in FIG. 1 form the imaging lens system, and a detection unit 4K using an image pickup device 24K as the two-dimensional detector such as the CCD is employed in place of the detector 24 shown in FIG. 1.

The use of the photo detector 24 obtains the information with respect to the intensity of the detection signal as the point information of the Raman scattering light to the observation object. Meanwhile, the use of the image pickup device 24K obtains the two-dimensional information (two-dimensional map) of the detection signal intensity of the Raman scattering light to the observation object.

The Raman scattering light at the different position on the living body 2 is formed into the image at the different position on the image pickup device 24K as shown in FIG. 6. The image pickup device 24K is driven by a drive signal from an image pickup device driver (hereinafter simply referred to as the driver) 19 provided in the signal process unit 5 such that the photoelectric converted image pickup signal (two-dimensional detection signal) is outputted to the amplifier 25.

In the signal process unit 5K shown in FIG. 6, frame memories 27K and 28K for storing image data (two-dimensional map of the detection signal data) corresponding to a single frame which have been picked up by the image pickup device 24K and A/D converted are provided in place of the signal memories 27 and 28 in the signal process unit 5 shown in FIG. 1.

The differential process circuit 29 executes the differential process with respect to the same pixel signal stored in the frame memories 27K and 28K. The signal corresponding to the differential processed Raman scattering intensity I^{R} is displayed on the display device 6 having the image display function.

A memory 29a for storing the differential processed data may be provided inside or outside the differential process circuit 29.

The aforementioned structure allows the band-pass light to be irradiated to the living body 2 in the two-dimensionally broadening manner. This makes it possible to obtain the two-dimensional information, that is, the image information of the Raman scattering light scattered in the two-dimensionally broadening manner without two-dimensionally scanning the detection unit 4.

### Second Embodiment

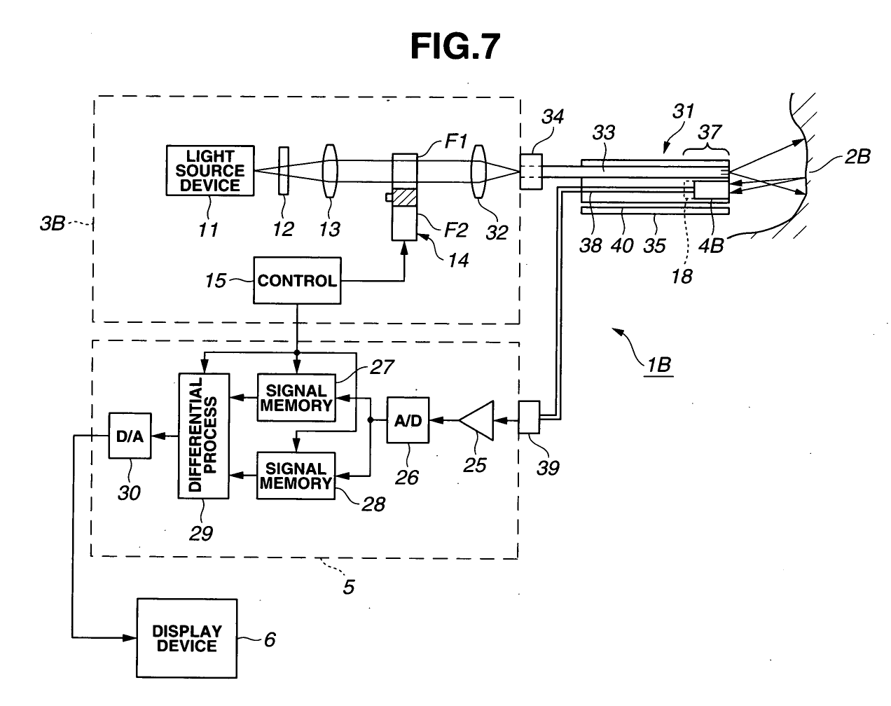

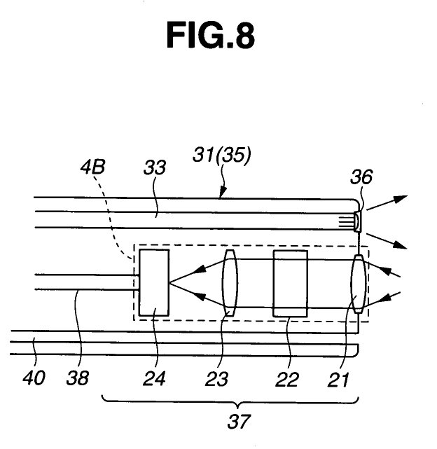

A second embodiment of the present invention will be described referring to FIGS. 7 and 8. FIG. 7 is a view showing a structure of an endoscope apparatus 1B which forms a Raman scattering light observation apparatus according to the second embodiment of the present invention. FIG. 8 is a view showing a structure of the distal end portion of an endoscope 31.

The embodiment is exemplified by the example of the structure of the endoscope apparatus 1B for observing the Raman scattering light using the endoscope 31 inserted into the body cavity, and more specifically, the structure where the detection unit 4 according to the first embodiment is attached to the distal end side of the endoscope 31.

The endoscope apparatus 11B shown in FIG. 7 includes a light source device 3B which generates illumination light, the endoscope 31 for irradiating the observation site 2B in the body cavity through guiding the light generated in the light source device 3B and equipped with the detection unit 4B detecting the scattering light therefrom, a signal process unit 5 for loading the signal detected by the detection unit 4B so as to be subjected to the signal process, and the display device 6.

The light source device 3B is formed by adding the condenser lens 32 for condensing the light passing through the rotary filter 14 and a light guide fixture 34 detachably connected to the incident end portion of the light guide 33 of the endoscope 31 to the light source device 3 shown in FIG. 1.

The light which has transmitted the rotary filter 14 is condensed by the condenser lens 32 on the incident end surface of the light guide 33 which is detachably fit with the light guide fixture 34 so as to be injected. The incident light on the incident end surface of the light guide 33 is guided by the light guide 33 inserted in the longitudinal direction of an insertion portion 35 of the endoscope 31 inserted into the body cavity.

The thus guided light is irradiated to the observation site 2B in the body cavity from the distal end surface of the light guide 33 via an illumination lens 36 (see FIG. 8) disposed on the distal end surface. The illumination lens 36 forms an incoherent light radiation portion.

Referring to FIG. 8, the detection unit 4B is stored in the distal end portion 37 of the insertion portion 35 at the portion adjacent to the illumination window to which the illumination lens 36 is attached. The detection unit 4B has the same structure as that of the detection unit 4 shown in FIG. 1. The same components as those shown in FIG. 1 will be designated with the same reference numerals, and the explanations thereof, thus, will be omitted.

The detection unit 4B detects the Raman scattering light component which contains the fluorescent component in the light scattered around the observation site 2B. The detector 24 of the detection unit 4B is connected to one end of a signal cable 38 inserted in the insertion portion 35. The other end of the signal cable 38 is detachably connected to the signal cable fixture 39 disposed in the signal process unit 5.

The signal detected by the detector 24 is inputted to the amplifier 25 in the signal process unit 5 through the signal cable 38 via the signal cable fixture 39.

Further structure and the signal process operation subsequent to those of the amplifier 25 are the same as those in the first embodiment. The endoscope 31 has a channel 40 which allows the treatment instrument such as the forceps to be inserted therein.

The basic structure of the present embodiment is substantially the same as that of the first embodiment except that the portion corresponding to the detection unit 4 shown in FIG. 1 is made further compact so as to be provided at the distal end portion 37 of the endoscope 31.

In the present embodiment, the insertion portion 35 may be inserted into the body cavity as a narrow space, for example, the esophagus and the large intestine for performing the Raman scattering light observation.

The Raman scattering light observation may be performed with the simple structure at lower costs likewise the first embodiment.

As the dotted line in FIG. 7 shows, a detection unit 4B may be equipped with a scanner unit 18 for two-dimensionally scanning the detection unit 4B to obtain the two dimensional Raman scattering light information from the observation site 2B so as to display the resultant information.

In the embodiment, the detection unit 4B may employ the optical system and the image pickup device for providing the two-dimensional image information to allow the image information of the Raman scattering light to be obtained as described in the modified example of the first embodiment.

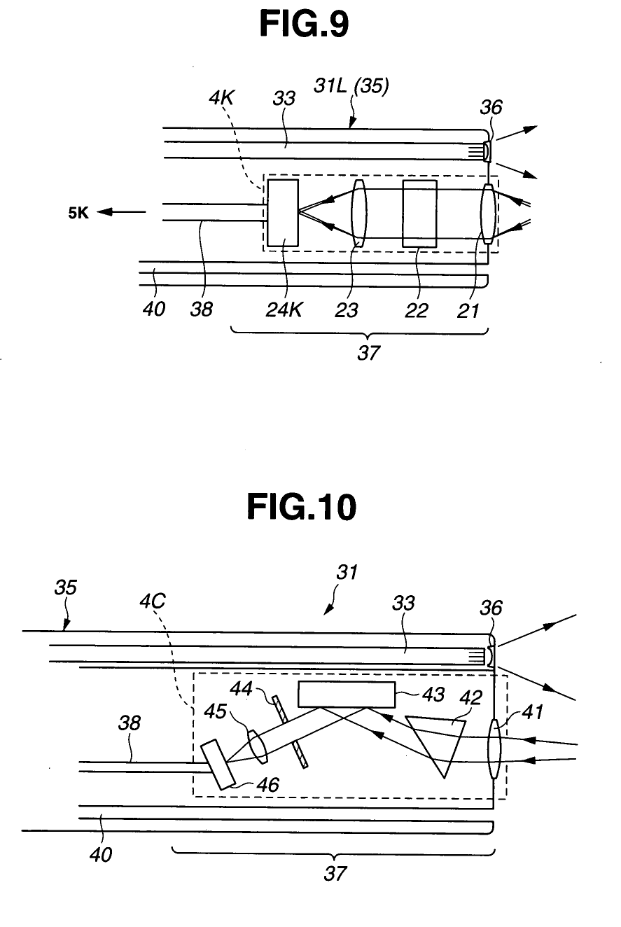

FIG. 9 shows the structure of the distal end portion of an endoscope 31L of the Raman scattering light observation apparatus or the endoscope apparatus according to the modified example of the second embodiment. The endoscope 31L is equipped with the detection unit 4K shown in FIG. 6 in place of the detection unit 4B shown in FIG. 8. The detection unit 4K employs the image pickup device 24K. In this case, the signal process unit 5K shown in FIG. 6 is employed in place of the signal process unit 5 shown in FIG. 7.

The band-pass light generated in the light source device 3B is irradiated to the observation site 2B via the endoscope 31L in the spatially broadening manner. The aforementioned irradiation allows the Raman scattering light which contains the fluorescent component radiated from the observation site 2B to be extracted by the band-pass filter 22 so as to be formed into the image on the image pickup device 24K.

The differential process is performed with respect to the detection signal of the image pickup device 24K, that is, the two-dimensional image signal corresponding to the space position information of the observation site 2B through the signal process unit 5K such that the fluorescent component mixed in the two-dimensional image signal is removed. This allows the display device 6 to display the image of the Raman scattering light.

### Third Embodiment

A third embodiment according to the present invention will be described referring to FIG. 10. The embodiment is formed by partially modifying the structure according to the second embodiment. More specifically, a detection unit 4C with the structure different from that of the detection unit 4B shown in FIG. 8 is attached to the distal end portion 37 of the endoscope 31.

The explanation with respect to the aforementioned structure will be specifically described. Referring to FIG. 10, the detection unit 4C is stored in a recess portion formed in the distal end portion 37 of the insertion portion 35 of the endoscope 31. The detection unit 4C has the structure different from that of the second embodiment in that the observation of the Raman scattering light is allowed without using the band-pass filter 22.

The detection unit 4C includes a lens 41 for collimating the light reflecting from the observation site 2B, a spectroscopic prism (hereinafter simply referred to as prism) 42 for dispersing the parallel collimated light, and a mirror 43 for reflecting the light dispersed (refracting in the different directions in accordance with the wavelength) by the prism 42.

The detection unit 4C further includes an aperture diaphragm 44 for narrowing down the light reflecting from the mirror 43, a lens 45 for condensing the light passing through the aperture diaphragm 44, and a detector 46 for detecting the light condensed by the lens 45.

The signal photoelectrically converted by the detector 46 is inputted to the signal process unit 5 shown in FIG. 6 via the signal cable 38. Other structure is the same as that of the second embodiment.

In the present embodiment, the lens 41 collimates the light reflecting from the observation site 2B. The collimated light is subjected to the spectroscopic process by the prism 42 so as to be reflected by the mirror 43.

The aperture diaphragm 44 disposed to open toward the direction where the light with the wavelength corresponding to the Raman scattering light to be detected is reflected serves to extract the light of the Raman scattering light component so as to be detected by the detector 46.

The output signal of the detector 46 is subjected to the same process as in the second embodiment. The present embodiment provides the Raman scattering information with good SNR as described below in addition to the same effect as that of the second embodiment.

The band-pass filter 22 used for detecting the Raman scattering light in the second embodiment serves to allow the light to pass the filter to separate the light with the wavelength of the object to be separated. However, as the light with the wavelength as the object to be separated is partially absorbed, the energy of the transmission light may be attenuated to a certain degree.

The detection signal with respect to the Raman scattering light is weakened to lower the SNR (S/N ratio) of the Raman component.

Meanwhile, the prism 42 employed in the embodiment performs the spectroscopic operation while hardly absorbing the light. The loss component may be suppressed compared with the mode using the band-pass filter 22.

Preferably, the prism 42 with substantially small size of several millimeters, for example, is used so as to be stored in the recess portion inside the distal end portion 37 of the endoscope 31. This makes it possible to observe the Raman scattering light with the simple structure at lower costs likewise the first embodiment.

In the embodiment, as the spectroscopic operation is performed by the prism 42, the incident light to the prism 42 is required to be collimated, which is not suitable for providing the two-dimensional image information without the scanner means.

### Fourth Embodiment

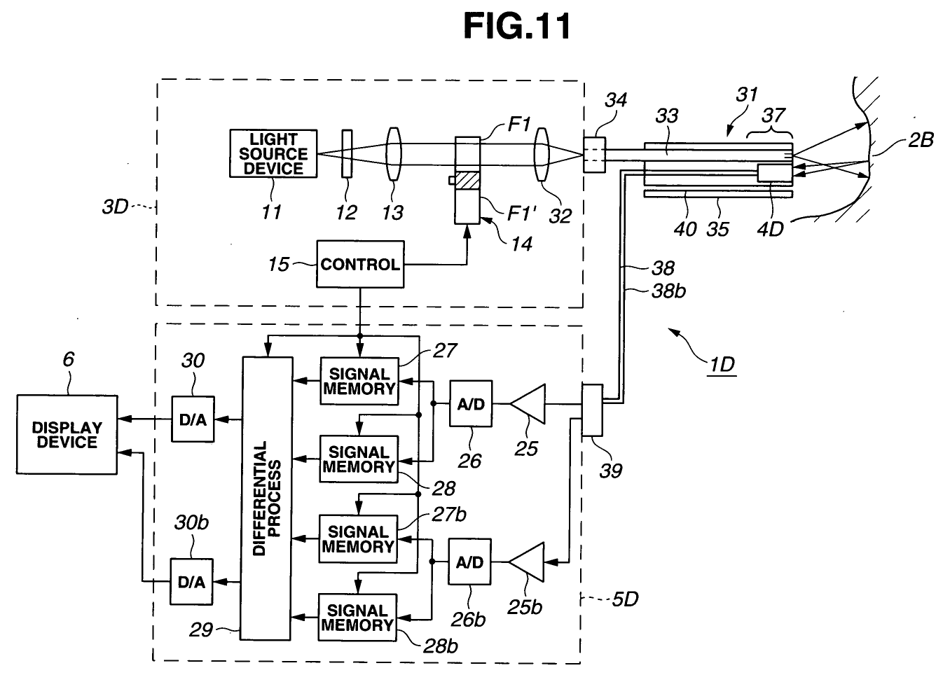

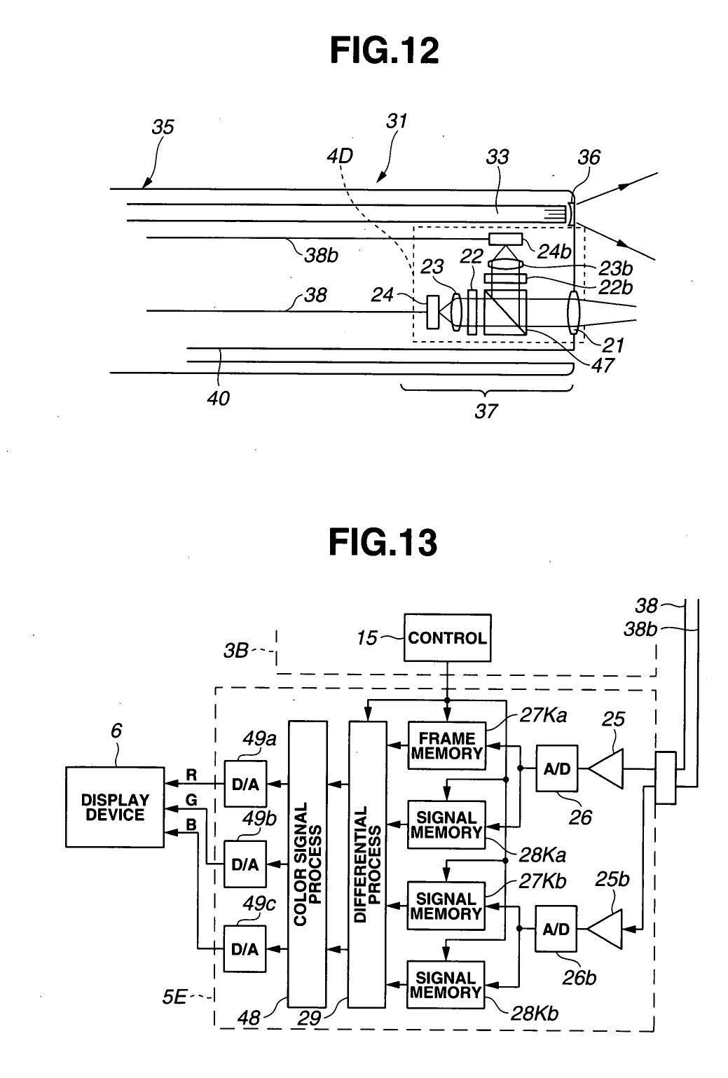

A fourth embodiment according to the present invention will be described referring to FIGS. 11 and 12. The structure of the detection unit in the fourth embodiment is different from that of the detection unit 4B attached to the distal end portion 37 of the endoscope 31 according to the second embodiment. Only the different point will be specifically described hereinafter.

FIG. 11 schematically shows the structure of the endoscope apparatus 1D which forms the Raman scattering light observation apparatus for observing two Raman scattering light each with the different wavelength (Raman band). FIG. 12 shows the structure of the distal end portion of the insertion portion of the endoscope 31.

Referring to FIG. 11, an endoscope apparatus 1D includes a light source device 3D, an endoscope 31 equipped with a detection unit 4D, a signal process unit 5D and a display device 6. The detection unit 4D as shown in FIG. 12 is attached to the distal end portion 37 of the insertion portion 35 of the endoscope 31.

The light source device 3D shown in FIG. 11 is formed by further adding a pair of filters F1′ and F2′ to the rotary filter 14 of the light source device 3 as shown in FIG. 1. In this case, the filters F1, F2, F1′ and F2′ are disposed each at a position of 90° on the circumference of the rotary filter 14. FIG. 11 shows the oppositely arranged filters F1 and F1′.

In the aforementioned case, the filters F1′ and F2′ are set to have different wavelengths from those of the above-structured filters F1 and F1 while functioning in the same way as the filters F1 and F2.

In this case, the filters F1 and F2 are used to irradiate the respective band-pass light to allow the corresponding band-pass filter 22 to extract (transmit) the Raman scattering light with the predetermined wavelength (specifically, λ₃).

In the present embodiment, each band-pass light is irradiated through the other filters F1′ and F2′, respectively to allow the corresponding band-pass filter 22b to extract the Raman scattering light with the other wavelength as described below.

For example, the band-pass filter 22 is set to have the center wavelength λ₃ to pass the Raman band of the molecule of the cancer tissue at the lesion, while setting the band-pass filter 22b to have the center wavelength λ₃′ to pass the Raman band of the molecule of the normal tissue at the lesion.

Referring to FIG. 12, the detection unit 4D attached to the distal end portion 37 is formed by disposing a half mirror 47 functioning as a beam splitter between the lens 21 and the band-pass filter 22.

The light reflecting from the half mirror 47 is injected to the band-pass filter 22b, and the light transmitting the band-pass filter 22b is condensed on the lens 23b to be detected by the detector 24b.

More specifically, the scattering light from the observation site 2B in the body cavity is formed into the collimate light by the lens 21, and the collimate light is injected into the half mirror 47. The light injected to the half mirror 47 is split into the transmission component and the reflection component which has been reflected.

The split transmission component allows passage of the Raman scattering light as the detection object via the band-pass filters 22 and 22b, and condensed by the lenses 23 and 23b, respectively so as to be injected to the detectors 24 and 24b.

Likewise the second embodiment, the signal detected by the detector 24 is inputted to the signal process unit 5D via the signal cable 38. The signal detected by the detector 24b is inputted to the signal process unit 5D via the signal cable 38b. In FIGS. 11 and 12, each of the signal cables 38 and 38b is represented by the single line for simplicity.

The signal process unit 5 shown in FIG. 7 is structured to process the signal detected by the detector 24. Meanwhile, the signal process unit 5D shown in FIG. 11 is structured to further process the signal detected by the detector 24b in the same manner as described above.

The detection signals outputted from the detectors 24 and 24b are amplified by the amplifiers 25 and 25b in the signal process unit 5D, respectively so as to be inputted to the A/D conversion circuits 26 and 26b and converted into the digital signals. The output signals of the A/D conversion circuits 26 and 26b are stored in the pairs of the signal memories 27, 28 and 27b, 28b sequentially in synchronization with the synchronizing signal from the control unit 15.

The pairs of the signals outputted from the pairs of the signal memories 27, 28 and 27b, 28b are subjected to the differential process performed in the differential process circuit 29 based on the formula 1, respectively.

The output signal from the differential process circuit 29 is converted into the analog signal in D/A conversion circuits 30 and 30b so as to be displayed on the display device 6.

Unlike the first to the third embodiments, the present embodiment allows observation of the plural Raman bands, which is expected to observe the characteristic of the observation site 2B in more detail.

In the embodiment, the image forming optical system and the image pickup device are used in the detection unit 4D so as to obtain the image information of the Raman scattering light with the plurality of wavelengths.

FIG. 13 is a view showing a signal process unit 5E in the modified example.

The RGB imaging based on the Raman scattering light may be realized by replacing the signal process unit 5D shown in FIG. 11 with the signal process unit 5E shown in FIG. 13. The signal process unit 5E employs frame memories 27K, 28K, 27Kb and 28Kb in place of the signal memories 27, 28, 27b and 28b shown in FIG. 11.

In the signal process unit 5E, the lenses 21, 23 and 23b of the detection unit 4D shown in FIG. 12 are connected to two image pickup devices for forming the image forming optical system to be used in place of the detectors 24 and 24b. The signal process unit 5E shown in FIG. 13 forms the Raman scattering light observation apparatus or the endoscope apparatus together with the detection unit equipped with the image pickup device.

The signal process unit 5E is equipped with a not shown driver for driving two image pickup devices.

The signal process unit 5E is provided with a color signal process circuit 48 for subjecting vector fᵢⱼ=(aᵢⱼ, cᵢⱼ)^{t} (t denotes transposition) with the output signal (aᵢⱼ, cᵢⱼ) of each pixel position (i, j) as the element outputted from the differential process circuit 29 to the color conversion so as to be outputted as the RGB signal in the signal process unit 5D shown in FIG. 11.

The color RGB signal generated in the color signal process circuit 48 is converted into analog color signals through the D/A conversion circuits 49a, 49b and 49c, respectively so as to be outputted to the display device 6. The pseudocolor display is made on the display surface of the display device 6.

The operation in the modified example is substantially the same as in the case shown in FIG. 11 until the differential process executed in the differential process circuit 29.

The calculation of 3×2 matrix S shown in the formula 2-1 is performed with respect to the two-dimensional vector fᵢⱼ=(aᵢⱼ, cᵢⱼ)^{t} with the two output signals (aᵢⱼ, cᵢⱼ) outputted from the differential process circuit 29 as the elements in the color signal process circuit 48 so as to obtain the RGB pixel value oⱼᵢ=(r_{ij, g}ᵢⱼ, bᵢⱼ)^{t} at the position defined by i and j based on the Raman scattering light observation result. The formula 2-2 represents the respective matrix components of the formula 2-1.

Finally, the display device 6 displays the oᵢⱼ=(rᵢⱼ, gᵢⱼ, bᵢⱼ)^{t} as the RGB image based on the Raman scattering light.

$$\begin{matrix}{o}_{ij} = {Sf}_{y} & ( 2 \text{-} 1 ) \\ {O}_{y} = ( \begin{matrix}{r}_{ij} \\ {g}_{ij} \\ {b}_{ij}\end{matrix} ) , S = ( \begin{matrix}{S}_{11} & {S}_{12} \\ {S}_{21} & {S}_{22} \\ {S}_{31} & {S}_{32}\end{matrix} ) , {f}_{y} = ( \begin{matrix}{a}_{ij} \\ {b}_{ij}\end{matrix} ) & ( 2 \text{-} 2 )\end{matrix}$$

According to the modified example, the image information based on the Raman scattering light is displayed in the pseudocolor to be easily identifiable or diagnosable.

### Fifth Embodiment

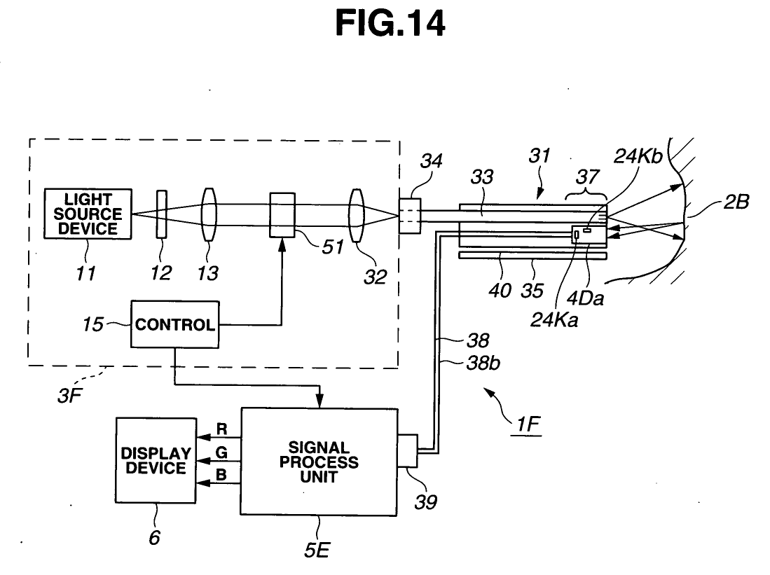

A fifth embodiment of the present invention will be described referring to FIG. 14. In the embodiment, a liquid crystal tunable filter (hereinafter referred to as LCTF) 51 is employed for a light source device 3F. FIG. 14 is a view showing an entire structure of the Raman scattering light observation apparatus 1F according to the fifth embodiment.

An endoscope apparatus 1F formed as the Raman scattering light observation apparatus according to the fifth embodiment shown in FIG. 14 includes a light source device 3F, the endoscope 31 equipped with a detector 4Da, a signal process unit 5E and the display device 6.

The light source device 3F is equipped with the LCTF 51 unlike the light source device 3B equipped with the rotary filter 14 shown in FIG. 11, for example.

The detection unit 4Da is equipped with the image pickup devices 24Ka and 24Kb unlike the detection unit 4D equipped with the detectors 24 and 24b shown in FIG. 12. FIG. 14 only shows the image pickup devices 24Ka and 24Kb as the main components of the detection unit 4Da for simplifying the explanation.

Other structures of the embodiment are the same as those of, for example, the modified example shown in FIG. 13. The light source device 3F according to the embodiment may be applied to the first to the fourth embodiments, respectively.

The LCTF 51 is capable of generating the band-pass light with the half bandwidth of several nms momentarily having an arbitrary center wavelength. The wavelength tuning speed may be set to be in the range from several tens ms to several hundreds ms within the short period (high speed). The wavelength scanner range may be set to be in the wide range from the visible range to the near-infrared range.

The apparatus structure of the present embodiment becomes somewhat more complicated than that of the system equipped with the rotary filter 14 as described above. However, there may be an advantage that the plural band-pass light may be generated over a wide waveband to provide the plural Raman bands from the observation site 2B.

The detection unit is required to be structured to obtain the plural Raman bands so as to obtain the plural Raman bands. The use of the LCTF 51 allows the measurement of the Raman spectrum. According to the embodiment, the effects derived from the first to the fourth embodiments may also be obtained.

### Sixth Embodiment

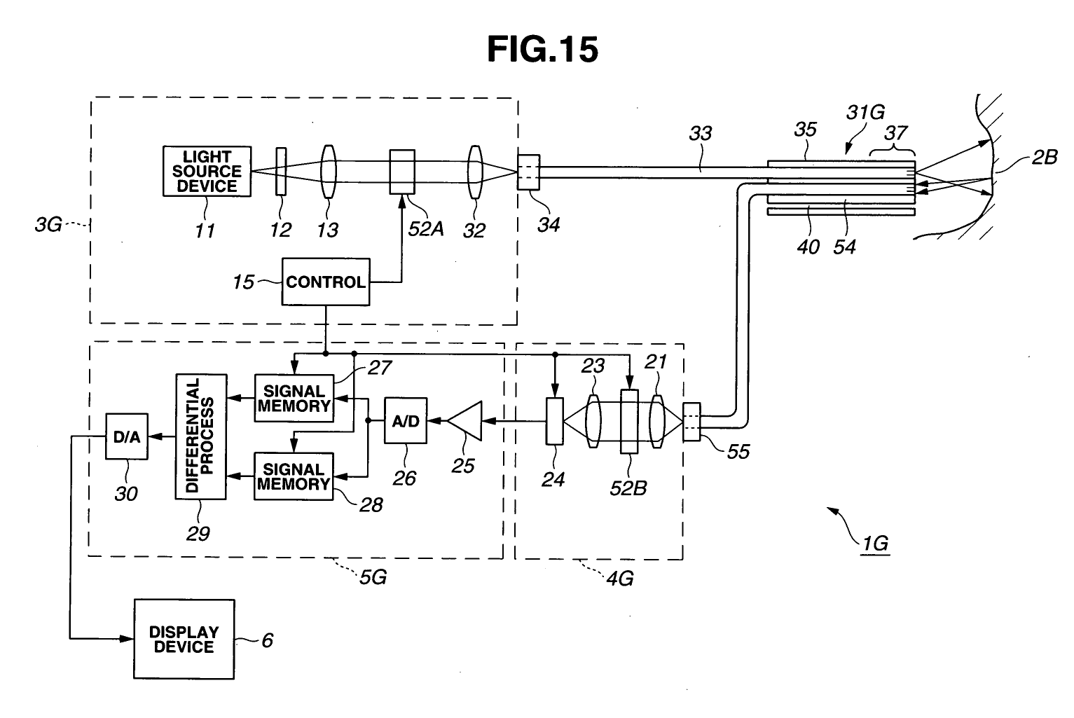

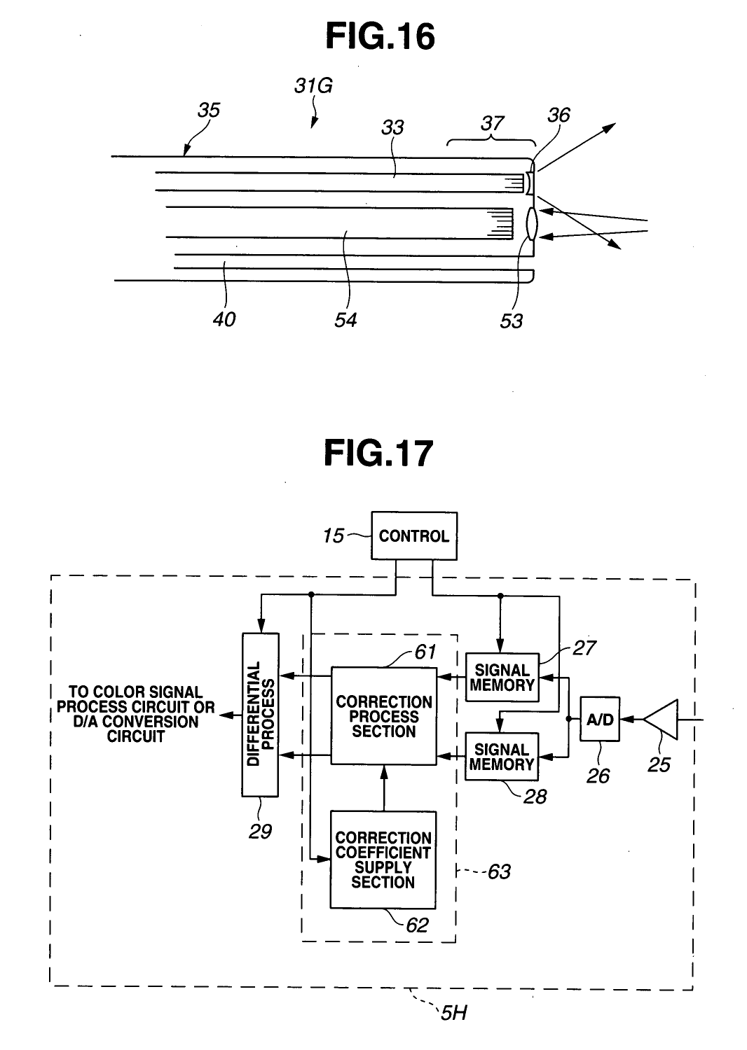

A sixth embodiment according to the present invention will be described referring to FIGS. 15 and 16. FIG. 15 is a view showing an endoscope apparatus 1G which forms the Raman scattering light observation apparatus of the sixth embodiment according to the present invention. FIG. 16 is a view showing the distal end portion of the endoscope.

The endoscope apparatus 1G according to the embodiment includes a light source device 3G, an optical endoscope (fiber scope) 31 a detection unit 4G, a signal process unit 5G and a display device 6 for displaying the detection result of the Raman scattering light.

The light source device 3G employs a wavelength variable filter unit 52A such as the LCTF 51 in place of the rotary filter 14 similarly to the light source device 3F as shown in FIG. 14. A lens 32 of the light source device 3G allows the band pass light to be supplied (injected) to an incident end of the light guide 33. The band-pass light is irradiated from the distal end surface of the light guide 33 to the observation site 2B in the body cavity via the illumination lens 36 as shown in FIG. 16.

The distal end portion 37 of the insertion portion 35 of the fiber scope 31G has an observation window formed adjacent to the illumination window, to which an objective lens 53 is attached as shown in FIG. 16. A distal end surface of an optical fiber bundle (hereinafter referred to as an optical fiber) 54 serving as the image guide (optical image transmission means) is disposed at the image forming position of the objective lens 53.

The light scattered at the observation site 2B are formed into the image on the distal end surface of the optical fiber 54 by the objective lens 53, and the image is transmitted to the rear end surface. The rear end surface of the optical fiber 54 is detachably connected to the optical fiber fixture 55 attached to the detection unit 4G.

Preferably, the optical fiber 54 is formed of quartz with low hydroxyl content which may cause the fluorescent noise therefrom during the optical transmission. The fiber scope 31G is also equipped with the channel 40. The fiberscope 31G includes no spectroscopic elements such as the detection unit and the band-pass filter. Those elements are provided inside the detection unit 4G which is disposed outside the fiberscope 31G.

The detection unit 4G shown in FIG. 15 employs a variable wavelength filter unit 52B such as the LCTF in place of the band-pass filter 22 in the detection unit 4 as shown in FIG. 1, that is, includes the lens 21 for collimating the light transmitted to the rear end surface of the optical fiber 54, the variable wavelength filter unit 52B, the condenser lens 23 and the detector 24.

The variable wavelength filter unit which allows the wavelength to be variable except the LCTF may be an acoustic optical filter, a variable wavelength filter based on the variable Fabry-Perot interferometer, and the variable wavelength filter with the electro-optic crystal. The LCTF is superior to the aforementioned components in view of the wavelength variable speed and the aperture.

The wavelength tuning of the variable wavelength filter unit 52B is performed in synchronization with the control signal from the control unit 15 which controls the operation of the variable wavelength filter unit 52A.

The signal outputted from the detection unit 24 is inputted to the signal process unit 5G The signal process unit 5 shown in FIG. 1, for example, may be employed as the signal process unit 5G.

The above-structured embodiment allows the use of the normal optical endoscope, that is, the fiber scope 31G for the Raman scattering light observation.

The use of the LCTF as the variable wavelength filter unit 52B of the detection unit 4G allows substantially momentary extraction of the Raman component with an arbitral wavelength from the Raman spectrum generated from the observation object.

In the aforementioned case, the apparatus structure is somewhat more complicated than that of the embodiments 1 to 5 each equipped with the band-pass filter 22. However, it is still excellent in the wavelength selection speed and the degree of freedom.

The signal process flow subsequent to the process executed in the detector 24 is the same as that of the second embodiment. The use of the image pickup device in place of the detector 24 and replacement of the signal process unit 5G shown in FIG. 15 with the signal process unit 5E shown in FIG. 13 allow the RGB imaging based on the Raman scattering light.

### Seventh Embodiment

A seventh embodiment according to the present invention will be described referring to FIG. 17. In the case where the portion with heavy mucosal pulsating, for example, esophagus is set as the observation object, the change in the relative positional relationship between the detector and the observation site may be easily anticipated. If the same observation site is photographed using the rotary filters F1 and F2 shown in FIG. 2, respectively, there may be the positional displacement between the two resultant monochrome images.

The change in the positional relationship between the detector and the observation site is expected to change the detection light intensity observed from the observation site at the corresponding position between those two images.

For this, the signal process unit 5H according to the embodiment as shown in FIG. 17 is equipped with correction means for correcting the variation in the detection light intensity in the front stage of the differential process circuit 29.

A correction section 63 formed of a correction process circuit 61 for correcting the variation in the detection light intensity and a correction coefficient supply section 62 is provided in the front stage of the differential process circuit 29 as shown in FIG. 17. The present embodiment is applicable to the signal process unit according to any one of the first to the sixth embodiments. The exemplary case applied to the first embodiment will be described hereinafter.

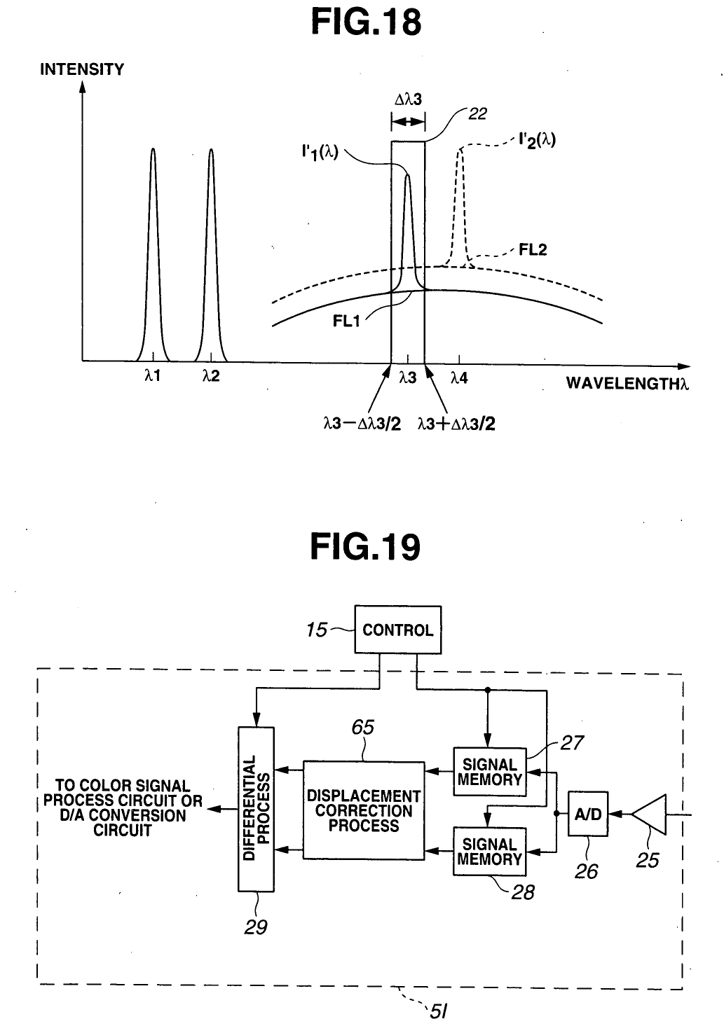

FIG. 18 is a view representing how the variation in the detection light intensity (mainly fluorescent intensity) generated by the change in the relative positional relationship between the detector and the observation object is corrected.

The light with the center wavelength λ₁ and the light with the center wavelength λ₂ different from the wavelength λ₁ by a predetermined wavelength are irradiated from the light source device to the living body 2 as the observation object in the time division manner such that the living body 2 generates the spectrums I′₁(λ) and I′₂(λ) each as the sum of the Raman scattering light component and the fluorescent component at the predetermined time interval.

Referring to FIG. 18, the change in the relative positional relationship between the detector and the observation object varies each fluorescent intensity inherent to the I′₁(λ) and I′₂(λ) (specifically, the fluorescent intensity component FL1 indicated by the solid line and the fluorescent intensity component FL2 indicated by the dashed line) in the wavelength range from λ₃−Δλ₃/2 to λ₃+Δλ₃/2.

The use of the correction coefficient a for making the difference components to substantially equal values in the formula 3-1 makes it possible to provide the Raman scattering intensity I having the variation in the measurement values owing to the change in the measurement condition reduced in spite of the change in the fluorescent intensity resulting from the changed relative positional relationship as described above.

Specifically, the correction coefficient a is supplied from the correction coefficient supply section 62 to the correction process circuit 61 in synchronization with the control signal from the control unit 15. Then the correction process is executed in the correction process circuit 61 through the calculation of the formula 3-2 using the supplied correction coefficient α.

The differential process as expressed by the formula 3-1 is executed in the differential process circuit 29 such that the output signal I from the differential process circuit 29 is finally transmitted to the color signal process circuit 48 or the D/A conversion circuit.

The value of the correction coefficient a is considered to become different depending on the living tissue as the observation object. However, the correction coefficient a may be set such that the I/I₁^{R} becomes the value equal to or larger than 0.99 in consideration for the case where the Raman scattering light intensity from the protein solution becomes hundredth part of or lower than the fluorescent intensity.

$$\begin{matrix}I = {I}_{1}^{R} - {I}_{2}^{R} = {\sum }_{λ = {λ}_{S} - Δ {λ}_{S} / 2}^{λ = {λ}_{S} + Δ {λ}_{S} / 2} \{ {I}_{1}^{′} ( λ ) - α {I}_{2}^{′} ( λ ) \} & ( 3 \text{-} 1 ) \\ {I}_{2}^{R} = {\sum }_{λ = {λ}_{S} - Δ {λ}_{S} / 2}^{λ = {λ}_{S} + Δ {λ}_{S} / 2} \{ α {I}_{2}^{′} ( λ ) \} & ( 3 \text{-} 2 )\end{matrix}$$

According to the embodiment, in the case where the relative positional relationship between the detector and the observation site changes as the portion of the observation object is likely to be influenced by the pulsating, for example, the esophagus, the influence may be reduced to allow observation of the Raman scattering light from the observation object.

### Eighth Embodiment

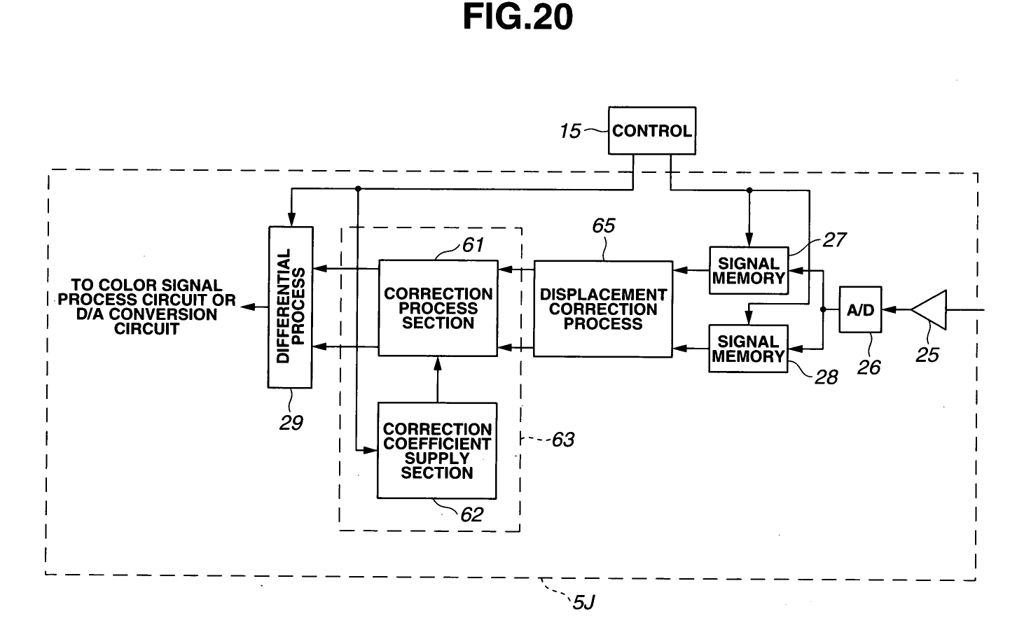

An eighth embodiment according to the present invention will be described referring to FIG. 19. In the embodiment, a signal process circuit is provided for correcting the spatial displacement between the photographed images resulting from the change in the relative positional relationship between the detector and the observation object. The term “displacement” is defined to be relevant to the expansion, reduction, parallel movement and rotation between the images.

FIG. 19 shows the structure of a signal process unit 51 in the eighth embodiment according to the present invention. The signal process unit 51 of the present embodiment is equipped with a displacement correction process circuit 65 for correcting the displacement in the front stage of the differential process circuit 29. In other words, the signal process unit 51 is equipped with the correction process means for correcting the spatial displacement on the two-dimensional map with respect to the detection signal intensity. The structure shown in FIG. 19 of the present embodiment is applicable to any one of the signal process units according to the first to the sixth embodiments.

The automatic superimposing of the images based on the linear image conversion and the non-linear image conversion may be considered as the exemplary correction process executed in the displacement correction process unit 65.

More specifically, the combination of the linear deformation and the non-linear warping is executed to allow the displacement correction process circuit 65 to deform the image for eliminating the displacement between the two images as the objects.

Referring to FIG. 20, a signal process unit 5J may be structured by adding the correction section 63 as described in the seventh embodiment formed of the correction process circuit 61 for correcting the variation component of the detection light intensity, and the correction coefficient supply section 62 to the rear stage of the displacement correction process circuit 65. The use of the signal process unit 5J shown in FIG. 20 makes it possible to detect the Raman scattering light more stably.

The embodiment makes it possible to correct the spatial displacement between the photographed images resulting from the change in the relative positional relationship between the detector and the observation object as well as provide the effects derived from the first to the sixth embodiments.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A Raman scattering light observation apparatus comprising:
a light source device for irradiating at least an incoherent first band-pass light with a center wavelength as a first wavelength, and an incoherent second band-pass light with a center wavelength as a second wavelength different from the first wavelength at a time interval;
a filter unit which receives an incident Raman scattering light that contains a fluorescent component from an observation object to which the first and the second band-pass light are irradiated at the time interval, so as to selectively extract a Raman scattering light component of the observation object as a third wavelength different from the first and the second wavelengths;
a detection unit for detecting a light extracted by the filter unit;
a signal process unit for subjecting a plurality of detection signals outputted from the detection unit to a signal process; and
a differential process unit provided in the signal process unit for executing a differential process with respect to a first detection signal detected by the detection unit via the filter unit upon irradiation of the first band-pass light, and a second detection signal detected by the detection unit via the filter unit upon irradiation of the second band-pass light.

2. The Raman scattering light observation apparatus according to claim 1, wherein a value between the center wavelengths of the first and the second band-pass light radiated from the light source device is set such that a spectrum value of the respective fluorescent components generated by the first and the second band-pass light is kept substantially unchanged.

3. The Raman scattering light observation apparatus according to claim 1, wherein the signal process unit is structured to execute a correction process in addition to the differential process for suppressing a difference component other than a Raman scattering light component between a detection signal intensity that contains the Raman scattering light component and the fluorescent component radiated from the observation object upon irradiation of the first band-pass light, and a detection signal intensity that contains the Raman scattering light component and the fluorescent component radiated from the observation object upon irradiation of the second band-pass light at the time interval from the irradiation of the first band-pass light.

4. The Raman scattering light observation apparatus according to claim 1, wherein the signal process unit executes a displacement correction process for correcting a spatial displacement between two-dimensional information with respect to a detection signal intensity that contains a Raman scattering light component and a fluorescent component radiated from the observation object upon irradiation of the first band-pass light, and two-dimensional information with respect to a detection signal intensity that contains the Raman scattering light component and the fluorescent component radiated from the observation object upon irradiation of the second band-pass light at a time interval from the irradiation of the first band-pass light.

5. The Raman scattering light observation apparatus according to claim 1, wherein the filter unit sets a band width of the third wavelength such that one of the Raman scattering light components radiated from the observation object to which the first and the second band-pass light are irradiated at the time interval is selectively extracted and the other of the Raman scattering light components is not extracted.

6. The Raman scattering light observation apparatus according to claim 1, wherein the differential process unit includes a memory which temporarily stores the first detection signal outputted from the detection unit upon irradiation of the first band-pass light and the second detection signal outputted from the detection unit upon irradiation of the second band-pass light, and a differential circuit which extracts a differential amount between the first detection signal and the second detection signal which have been stored in the memory.

7. The Raman scattering light observation apparatus according to claim 1, wherein the filter unit is formed of a band-pass filter unit which is set to selectively transmit the third wavelength.

8. The Raman scattering light observation apparatus according to claim 7, wherein the band-pass filter unit includes at least one band-pass filter element which is set to selectively transmit the third wavelength between the observation object and the detection unit.

9. The Raman scattering light observation apparatus according to claim 1, wherein the filter unit includes a spectroscopic prism set to selectively extract the third wavelength.

10. The Raman scattering light observation apparatus according to claim 1, wherein the light source device includes a plurality of narrow band transmission filters for generating at least the first and the second band-pass light.

11. The Raman scattering light observation apparatus according to claim 1 further comprising an endoscope which irradiates a spatially broadening light to the observation object.

12. The Raman scattering light observation apparatus according to claim 1, wherein the detection unit includes an optical system which allows a light that has passed the filter unit to be formed into an image, and a two-dimensional detector provided at an image forming position.

13. The Raman scattering light observation apparatus according to claim 1 further comprising a scanner unit for two-dimensionally scanning the detection unit.

14. The Raman scattering light observation apparatus according to claim 1, wherein the light source device includes a first band-pass filter which selectively transmits the first band-pass light and the second band-pass light, and a rotatably driven rotary filter equipped with the first band-pass filter.

15. The Raman scattering light observation apparatus according to claim 12, wherein the differential process unit includes a memory which temporarily stores the two-dimensional first detection signal outputted from the image pickup device upon irradiation of the first band-pass light and the two-dimensional second detection signal outputted from the detection unit upon irradiation of the second band-pass light, and a differential circuit which extracts a differential amount between the two-dimensional first and the second detection signals which have been stored in the memory.

16. The Raman scattering light observation apparatus according to claim 1, wherein the light source device radiates incoherent light each with the first wavelength and the second wavelength as the first band-pass light and the second band-pass light, and further radiates incoherent light each with a fourth wavelength and a fifth wavelength different from the first and the second wavelengths, respectively at a time interval.

17. The Raman scattering light observation apparatus according to claim 16, wherein the differential process circuit subjects the first and the second detection signals to a first differential process upon radiation of incoherent light each with the first and the second wavelengths, and further subjects the first and the second detection signals to a second differential process upon radiation of incoherent light each with the fourth and the fifth wavelengths.

18. The Raman scattering light observation apparatus according to claim 17, further comprising a color signal generation circuit for generating different color signals from the first and the second differential signals outputted from the first and the second differential processes, respectively.

19. The Raman scattering light observation apparatus according to claim 18, further comprising a display unit for displaying the color signal.

20. An endoscope apparatus comprising:
an endoscope with an insertion portion to be inserted into a body cavity;
a light radiation portion provided at a distal end portion of the insertion portion for radiating at least an incoherent first band-pass light with a first wavelength as a center wavelength and an incoherent second band-pass light with a second wavelength as a center wavelength that is different from the first wavelength to an observation site in the body cavity at a time interval;
a filter unit provided at a distal end portion of the insertion portion for receiving an incident Raman scattering light that contains a fluorescent component from the observation site to which the first and the second band-pass light are irradiated at a time interval to selectively extract a Raman scattering light component at the observation site as a third wavelength which is different from the first and the second wavelengths;
a detection unit for detecting a light extracted by the filter unit;
a signal process unit for subjecting a plurality of detection signals outputted from the detection unit to a signal process; and
a differential process unit provided in the signal process unit for executing a differential process with respect to a first detection signal detected by the detection unit via the filter unit upon irradiation of the first band-pass light, and a second detection signal detected by the detection unit via the filter unit upon irradiation of the second band-pass light.

21. The endoscope apparatus according to claim 20, further comprising a light source device for generating the first band-pass light and the second band-pass light at the time interval, wherein the first and the second band-pass light generated in the light source device are radiated from a distal end surface of the light guide disposed at a distal end portion in the endoscope via the light radiation portion.
